(19) United States
(12) Patent Application Publication
(10) Pub. No.: US 2013/0019721 A1
(43) Pub. Date: Jan. 24, 2013

(54) TILTING SCREW BIT AND SCREW BIT HOLDER

(71) Applicant: Athanasios T. Starogiannis, Wake Forest, NC (US)

(72) Inventor: Athanasios T. Starogiannis, Wake Forest, NC (US)

(21) Appl. No.: 13/184,618

(22) Filed: Jul. 18, 2011

(51) Int. Cl. B25B 15/00

(52) U.S. Cl. 81/436

(57) ABSTRACT

The present invention provides a screw bit and holder system wherein the screw bit is capable of tilting or swiveling in order to work at angles off of perpendicular to a screw head. The base of the bit is rounded with sides that are flat to prevent rotating the bit while allowing a tilt.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a screwdriver or a screwdriver attachment. In particular, the present invention relates to a screw driving device with the capability to swivel the head and work at angles off from perpendicular to a screw head.

2. Description of Related Art

Screwdrivers and attachments to handles with multiple screwdriver heads for driving screws are both powered or hand type devices and relatively common in the art. These devices have a screwing head with a screw tip bit, either part of the screwdriver itself or as a replicable head bit, allowing the user to replace broken head bits and to use one handle or drill for a multiplicity of different screw driving bits.

Normally, in use, a screw head is matched to the particular screw to be driven and the head placed on the screw at about a 90 degree angle to the screw head or roughly parallel to the screw shaft. While the screw driver head can be utilized off of 90 degrees by a couple of degrees or so without problem, if there is a need to angle the drill or screwdriver by more than that amount, the user risks stripping the screw head and damaging the screw driver head or both. The torque necessary to drive a screw is derived by the contact of the screw head with the screw driver head. The less contact the greater the force necessary to drive the screw in place as well.

Screw bits are normally designed with a screw tip at the distal end and a polygonal shaped shaft (usually hexagonal) at the proximal end. The proximal end of the bit is inserted into a sleeve whose inside walls are slightly larger than the circumference of the proximal end of the bit and having a matching polygonal shape such that the proximal end of the bit is inserted into the sleeve distal end by matching the polygonal shaft into a polygonal hole. The matching polygons (hexagons) keep the bit from rotating as well as keep the bit parallel to the screwdriver shaft. The bit is kept in place by use of a magnet recessed in the sleeve where the bit rests against it in use.

Not much has been designed that deals with all the problems associated with offset use of a screwing device. Attempts have been made to produce screwing devices with a head that angles but it requires multiple moving parts, laborious assembly, and must be locked in place to use. Frequently it is necessary to change the angle of a screwdriver during use and the current devices do not allow this variation in use at all without stopping each time the angle needs to be changed.

Accordingly, there is a need for a device that is capable of driving screws off of perpendicular, is cost effective to make and sell, is simple in design, and that is capable of changing angle easily during application to a screw without the need to stop to adjust the screw head angle.

### BRIEF SUMMARY OF THE INVENTION

The present invention relates to a device with replaceable heads which allows the specially designed heads to move anywhere from approximately 45 to 90 degrees relative to a screw head.

In one embodiment of the intention, there is a device for driving screws comprising:
a) a screw bit holder comprising a shank end piece having a distal end sleeve with a distal end aperture for inserting a screw bit; a magnetic screw bit holder at a depth recessed in the aperture and an aperture inner circumferential wall, the inner wall polygonally adapted to accept a screw bit with a matching polygonal proximal end sides; and
b) a screw bit having a screw driving distal end and a proximal end shaft the proximal end having a rounded tip, matching polygonal proximal end sides the proximal end shaft having a length less than depth of the recessed magnetic screw bit holder and a middle shaft narrower than the proximal end shaft separating the distal and proximal ends; wherein when the screw bit proximal end shaft is placed in the aperture it engages the holder at a position such that the middle shaft is positioned adjacent to the aperture.

In another embodiment, there is a screw bit for insertion in a screw bit holder having a distal aperture and a magnetic screw bit holder at a depth recessed in the aperture and an aperture inner circumferential wall, the inner wall polygonally adapted to accept a screw bit with a matching polygonal proximal end sides comprising:
a) a screw driving distal end;
b) a proximal end shaft, the proximal end having a rounded tip, polygonal proximal end sides the proximal end shaft having a length less than depth of the recessed magnetic screw bit holder; and
c) a middle shaft narrower than the proximal end shaft separating the distal and proximal ends; wherein when the screw bit proximal end shaft is placed in the aperture it engages the holder at a position such that the middle shaft is positioned adjacent to the aperture.

### BRIEF DESCRIPTION OF THE DRAWINGS

FIG. 1 is an exploded perspective view of a screw bit holder and a screw bit of the invention.

FIG. 2 is a perspective view of the holder and bit together.

FIG. 3 is an embodiment wherein the screw bit holder is a screwdriver handle with the bit angled for use.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used here the term “device for driving screws” refers to manual or motorized devices that have bit heads for screwing into place flat head screws, Phillip's screws, Allen head screws and devices, star head screws, and the like. These devices comprise a handle portion, a shaft, and a crew bit portion, and such devices are well known in the art. Recently a two piece device has become available consisting of a screw bit which is separate from the handle and shaft, and a screw bit holder which holds the screw bit in place and allows for easy replacement of screw bits with different screw heads or when the bit is damaged.

The “screw bit holder” consist of a piece comprising a shank end piece having a distal end sleeve with a distal end aperture for inserting a screw bit. These devices can be integral or fixedly attached to the shaft of a handle/shaft, or can be separate and polygonally adapted to attach to a motorized rotating shaft of a drill or to another magnetic screw bit holder (one bit holder held by another bit holder). Normally the aperture end is fairly deep and is designed to prevent rotation of the bit and for that manner any rotation or movement whatsoever. The present screw bit holder has a magnetic screw bit holder, a depth recessed in the aperture, and an aperture inner circumferential wall, the inner wall polygonally adapted to accept a screw bit with a matching polygonal proximal end sides. Since in most cases (as depicted in the drawings) the proximal end of the present invention bits are shorter than traditional screw bits, the depth of the aperture will need to be based on being shorter than the proximal end of the invention bit. One will be able to see from the drawings how this is accomplished but longer or shorter bits and depths can be accomplished as long as the bit and depth are matched accordingly as further explained herein.

The “screw bit” of the present invention has a screw driving distal end designed to drive a desired screw head. The proximal end shaft has a rounded tip and polygonal sides that match the inner wall of the matching screw bit holder. It also has a shaft having a length less than the depth of the recessed magnetic screw bit holder, however, not so short that the screw driving end is blocked or otherwise obscured from use. The bit has a middle shaft that is narrower than the proximal end shaft and separates the distal and proximal ends from each other. The overall design is such that when the screw bit proximal end shaft is placed in the aperture of the matching screw bit holder, it engages the magnet and positions the middle shaft approximately adjacent to the aperture. This bit then is prevented from rotation by the polygonal sides engaging the inner walls of the screw bit holder but because of the length of the screw bit in combination with the rounded bottom of the bit, the bit can be angled from parallel to the axis of the screw bit holder to where it engages the edge of the aperture. In other words, the bit can have an angle of from about zero degrees off axis to as much as about forty-five degrees or more. The optimum maximum angle will depend on the combination of elements of the design as well as the construction materials utilized. Obviously, the bit must be made of a magnetic material such as iron, or the like, and essentially the entire device is, in an embodiment, made entirely of a tool grade of iron, steel, or the like.

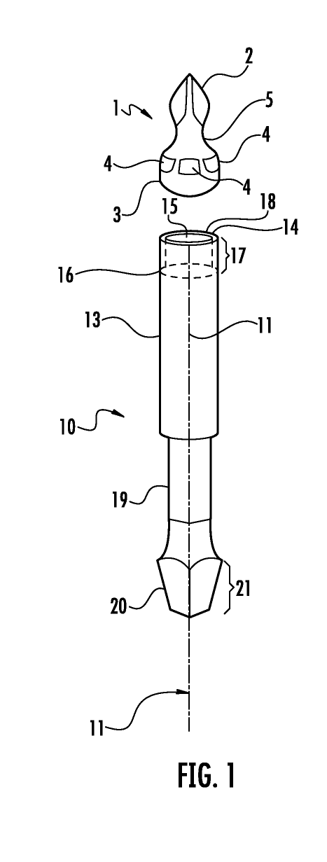

Now referring to the drawings, FIG. 1 is an exploded view of the bit and bit holder of the present invention. In this view we can see rotating bit 1 which has in this embodiment a Phillip's screw driving tip 2 at the distal end of the bit 1. At the opposite proximal end of the bit 1 is a rounded end 3. On the sides of the rounded end 3, are flat sides 4. In this embodiment there are six flat sides creating a hexagonal configuration (though any polygonal configuration could be used) which is standard for drill bit tips of all kinds along with drill bit holders which have a hexagonal inner circumference. The middle shaft 5 is narrower than the rounded end 3 and aids in the mobility of the rotating bit when in use.

The screw bit holder 10 is designed for holding the screw bit 3 and allowing it to rotate off of axis 11. The shank end piece 13 has shank distal end 14 with an aperture 15 for inserting the rotating bit 1. A magnetic screw bit holder 16 (shown in dotted line fashion and not otherwise viewable) holds bit 1 in place but allows for rotation against the rounded end 3. The magnetic holder is at a depth 17 which is determined such that when the bit 1 is placed against the magnet holder 16 the bit 1 is held such that middle shaft 5 is roughly around the distal end 14. The aperture 15 has inner wall 18 which is polygonal (hexagonal in the drawing) adapted such that it holds the bit 1 and prevents it from rotating in the aperture but not from tipping at an angle off of axis 11.

The bit holder in this view has holder middle shaft 19 and bit attachment end 20 designed for insertion into a drill chuck or into a standard drill bit holder for standard drill bits which tend to be deeper than those of the present invention since height 21 can be greater than the corresponding area in the bit of the present invention. The shorter end of bit 1 ensures a greater rotation than if the end is longer.

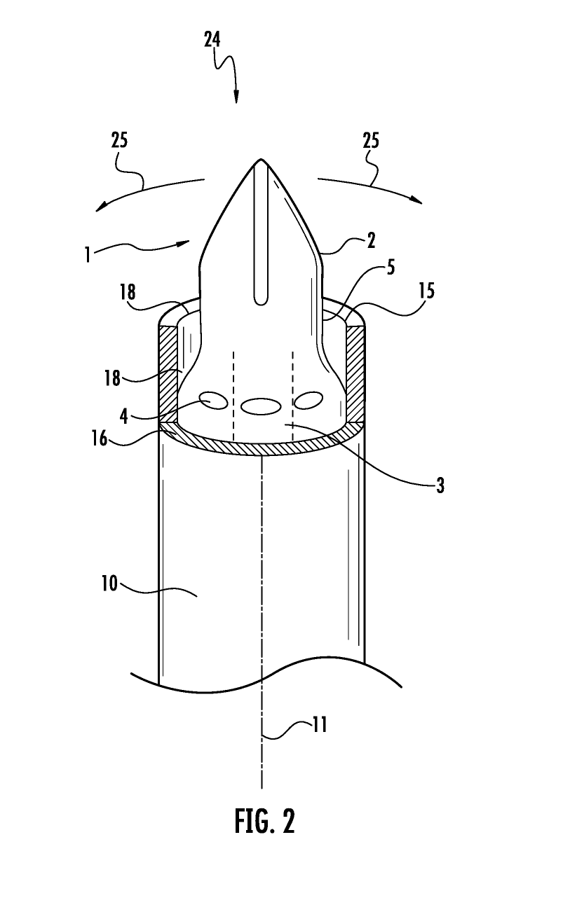

In FIG. 2 we see a close up of the bit 1 in a bit holder 10. The bit end 3 is held by the magnetic forces of magnetic bit holder 16. Arrow 24 with the X through it indicates that the bit cannot rotate circumferentially with in aperture 15. This is because bit sides 4 engage the internal sides 18 of the bit holder 10 and prevent rotation. Arrows 25 indicate that the bit 1 can tilt in an off axis 11 way up to the point that middle shaft 5 is stopped by the edge of the aperture. The narrow middle shaft 5 has narrow sides to aide in giving the largest amount of tilt. One skilled in the art can determine how narrow or wide to make and exactly how to position the bit and what size based on these drawings and the description herein to maximize the tilt without sacrificing strength and durability.

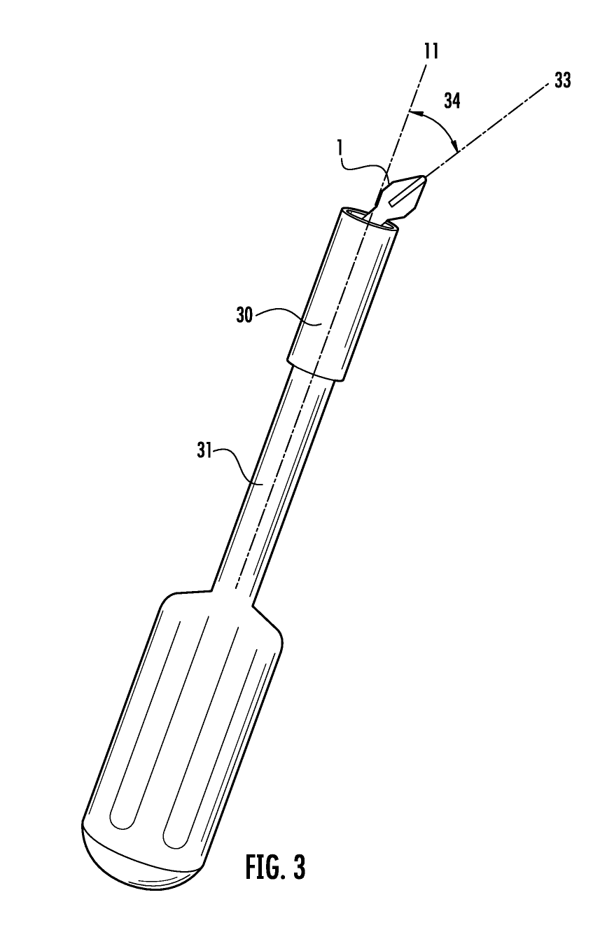

In FIG. 3 we see the screw bit holder as part of a screw driver bit holder type device. We also can see the angle that the bit 1 can be moved to. In this figure, screwdriver handle has screw bit holder 30 attached at the distal end of the device. It is identical to the screw bit holder shown in FIG. 1 except the proximal end is the screwdriver handle 31 instead of the middle shaft 19 and end 20 shown in that figure. This view shows how the bit 1 can be angled off of axis 11. In this view bit 1 is tilted and pointing in direction 33 which creates angle 34 between axis 11 and pointing direction 33. This angle can be from zero to about forty-five degrees or more depending on the exact design of the device including the diameter of the aperture, how narrow the middle shaft is compared to the proximal end of the bit, and the like. In this view the bit 1 is tiled about forty-five degrees and can be utilized to screw a Phillip's head screw without angling the whole screw driver which in some cases might be impossible.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A device for driving screws comprising:
a) a screw bit holder comprising a shank end piece having a distal end sleeve with a distal end aperture for inserting a screw bit; a magnetic screw bit holder at a depth recessed in the aperture and an aperture inner circumferential wall, the inner wall polygonally adapted to accept a screw bit with a matching polygonal proximal end sides; and
b) a screw bit having a screw driving distal end and a proximal end shaft the proximal end having a rounded tip, matching polygonal proximal end sides the proximal end shaft having a length less than depth of the recessed magnetic screw bit holder and a middle shaft narrower than the proximal end shaft separating the distal and proximal ends; wherein when the screw bit proximal end shaft is placed in the aperture it engages the holder at a position such that the middle shaft is positioned adjacent to the aperture.

2. The device according to claim 1 wherein the shank end piece is polygonally adapted to be inserted in a magnetic screw bit holder.

3. The device according to claim 2 wherein the shank end piece is inserted in a screwdriver shaft having a screw bit holder distal end.

4. The device according to claim 1 wherein the shank end piece is attached to a motorized rotating shaft having a magnetic screw bit holder.

5. The device according to claim 1 wherein the screw bit holder in a) is fixedly mounted on a screwdriver.

6. A screw bit for insertion in a screw bit holder having a distal aperture and a magnetic screw bit holder at a depth recessed in the aperture and an aperture inner circumferential wall, the inner wall polygonally adapted to accept a screw bit with a matching polygonal proximal end sides comprising:
a) a screw driving distal end;
b) a proximal end shaft, the proximal end having a rounded tip, polygonal proximal end sides the proximal end shaft having a length less than depth of the recessed magnetic screw bit holder; and
c) a middle shaft narrower than the proximal end shaft separating the distal and proximal ends; wherein when the screw bit proximal end shaft is placed in the aperture it engages the holder at a position such that the middle shaft is positioned adjacent to the aperture.
